(19) United States
(12) Patent Application Publication
(10) Pub. No.: US 2013/0137330 A1
(43) Pub. Date: May 30, 2013

(54) Device and Method for Producing a Molding Pulp Part and Molding Pulp Part

(71) Applicant: Heinrich Grimm, Bad Salzdetfurth (DE)

(72) Inventor: Heinrich Grimm, Bad Salzdetfurth (DE)

(21) Appl. No.: 13/814,842

(22) PCT Filed: Jul. 20, 2011
(86) PCT No.: PCT/DE11/01492

§ 371 Date: Feb. 7, 2013

(30) Foreign Application Priority Data
Aug. 10, 2010 (DE) 1 2010 034 159.2
Jan. 19, 2011 (DE) 10 2011 009 137.8

(51) Int. Cl. B29C 41/36; D04H 13/00

(52) U.S. Cl. CPC B29C 41/36; D04H 13/00
USPC 442/366; 425/145; 264/108

(57) ABSTRACT

The invention relates to a device for producing a molded pulp part (10), comprising a pneumatic fiber feeding apparatus (2) having an associated heating apparatus (4) having at least one heat exchanger (6) for heating up heating air and a mold (12), which has through-flow holes (14) for the transport air on at least one side, wherein the mold (12) has an outlet controller (20) arranged on the side of the through-flow holes (14), said outlet controller having a plurality of outlet openings (22), which can be closed and which are arranged one behind the other in the feeding direction of the fibers.

The invention relates to an apparatus and a process for producing a fiber molding comprising a pneumatic fiber-feeding device with an assigned heating device having at least one heat exchanger for heating the heating air and a mold which has on at least one side through-flow holes for the transporting air. The invention likewise relates to a fiber molding of a thermally crosslinkable fiber material which has been crosslinked in a corresponding mold while thermal energy is supplied, the fiber molding having an upper side which is aligned perpendicularly to the main loading direction of the fiber molding. The apparatus, the process and the fiber molding itself are suitable in particular for producing three-dimensional upholstery elements or components that have not only adequate stability in a main loading direction but also sufficient dimensional stability.

Fiber moldings can be produced in various ways. One process provides that the fibers to be bonded to one another, which consist of a thermally crosslinkable material, are placed in a mold and heated. Thermally crosslinkable materials are for example natural fibers that are coated with a thermoplastic layer. Hemp, flax, sisal or bamboo may be used for example as natural fibers. Likewise, a polyester fiber or a polyester bicomponent fiber may be used for example. The fiber material is heated by means of a heat source, in particular a heating-air blower, until the bonding together of the fibers has taken place. Subsequently, the finished fiber molding is removed from the mold.

The production of fiber moldings that are intended to have a spring effect perpendicularly to the main loading direction is problematic, in particular in the case of relatively flat 3D moldings such as seat cushions or seat backrests.

The object of the present invention is to provide an apparatus and a process for producing a fiber molding and to provide a fiber molding as such with which an improved product can be produced as effectively as possible.

According to the invention, this object is achieved by an apparatus with the features of the main claim, a process with the features of the independent claim and a fiber molding according to the independent product claim. Advantageous configurations and developments of the invention are disclosed in the dependent claims, the description and the figures.

The apparatus according to the invention for producing a fiber molding, comprising a pneumatic feeding device with an assigned heating device having at least one heat exchanger for heating heating air and a mold which has on at least one side through-flow holes for the transporting air, provides that the mold has an outlet controller which is arranged on the side of the through-flow holes and has a number of closable outlet openings arranged one behind the other in the feeding direction of the fibers.

The arrangement of the outlet controller makes it possible to achieve an alignment of the fibers within the mold. The through-flow holes are preferably arranged over the entire length of the mold, that is to say along the feeding direction of the fibers, so that the fibers can be successively arranged in layers. The through-flow holes are in this case arranged in such a way that a diversion of the transporting air stream takes place, that is to say that there is a preferably perpendicular deflection of the transporting air in relation to the feeding direction. The closable outlet openings make it possible to isolate regions in the mold from a through-flow, in that the outlet openings are closed or remain closed. On account of the flow profile of the transporting air, that region of the mold that lies in the region of the opened outlet openings is preferentially filled with fibers. This makes it possible to achieve a controlled filling of the mold and a directed orientation of the fibers within the mold.

A suction-air connection, by which the transporting air can be sucked out from the mold, is preferably arranged behind the outlet controller in the direction of flow of the transporting air. This allows accelerated filling of the mold to be achieved.

The outlet controller may have flaps or slide valves as closure devices for the outlet openings, in order to achieve a simple, quick-to-operate and reliable opening or closing of the outlet openings.

The apparatus may have a blower, which is assigned to the heat exchanger and fills the mold with fibers via a compressed-air connection connected to the pressure side of the blower. The suction-air connection of the mold may be connected to the suction side of the blower, so that it is possible to conduct the transporting and heating air in a circulating process, so that the blower air that has flowed through the molding can be returned with the residual heat to the heat exchanger and used for heating the fiber molding or the fiber material within the mold.

The mold preferably has through-flow holes on sides lying opposite one another, the suction-air connections also being arranged on sides of the mold lying opposite one another. This makes it possible for the mold to be filled evenly by a deflected air flow. The heating air may either be conducted like the transporting air in the mold or conducted separately, for example in that a suction-air connection is connected to the pressure side of a blower, so that a complete through-flow of the mold can take place without deflection of the air stream. The arrangement of the through-flow holes and the pressure- and suction-air connections in this way makes it possible to influence the air conduction, so that heating of the fiber material that is as even and uniform as possible can take place. The same applies to cooling of the mold and of the molding after heating.

Screening plates with through-flow holes may be arranged on or in the mold, in order on the one hand to retain the fibers of the fiber material in the mold and on the other hand to allow a through-flow with the blower air.

In order to achieve the effect that heating that is as quick and even as possible takes place even in the case of complex shapes of a fiber molding, it is provided that in the mold there are regions with different fiber densities or fiber thicknesses and that the free flow cross section of the through-flow holes is greater in regions of great fiber density or fiber thickness than in regions of low fiber density or fiber thickness. In other words, very large or a very large number of through-flow holes are arranged in those regions of the mold that form particularly thick regions of the fiber molding or in those regions in which there is a high compression of the fiber material. In regions of the mold in which there are only few fibers or fibers with a low compression, and consequently a low fiber density, there may be smaller through-flow holes or fewer through-flow holes per unit area. The fiber thickness or fiber molding thickness should in this case be assessed with regard to the direction of flow of the heating air stream. The longer the path in the mold to be flowed through, the greater the fiber thickness.

A variant of the invention provides that the mold is divided and the mold parts are mounted displaceably in relation to one another. The dividing and opening of the mold makes it possible that the filling volume can be increased significantly. The opening and filling with fibers allows the degree of compression of the fibers to be regulated, so that among the factors by which the density of the final product can be influenced is the degree to which the mold parts are moved in relation to one another. In addition, influencing takes place by the amount of fibers fed in, that is to say by way of the amount of fibers introduced into the mold.

The mold is preferably arranged in such a way that the feeding direction of the fibers corresponds substantially to the direction of gravitational force. In the usual orientation, this means that in the case of flat fiber moldings the large surfaces of the main loading directions, for example the surfaces of seat cushions or seat backrests, are arranged substantially perpendicularly.

In order to ensure a better assignment of the outlet openings to the closure devices, air-directing devices are arranged between the mold and the outlet controller, the air-directing devices separating the outlet openings from one another. The separating of the outlet openings from one another may in this case take place completely in terms of flow, that is to say such that there is no flow communication between the individual outlet openings, or by predominantly reducing the overflow from the air-directing devices to other outlet openings. Therefore, there does not have to be a hermetic sealing between the individual outlet openings. The air-directing devices have the effect of providing ventilation shafts or ventilation channels within the mold, which direct the transporting air or the heating air from the molding through the outlet openings to the suction-air connections.

A fiber bunker is preferably coupled to the blower, so that the fibers are blown or sucked into the mold from the fiber bunker by way of a fiber transporting line. For this purpose, it may be provided that the heating air circuit is isolated from the blower, so that the sucking up and blowing in of the fibers into the mold is not performed with hot air but by way of normal ambient air. The isolation may take place by way of slide valves.

In order to be able to allow quicker removal of the finished fiber moldings, coupled to the blower is a cooling air channel, which is arranged separately from the heat exchanger and is connected to the mold. Separate forming of the hot air channel and cooling air channel makes it possible to direct cooling air through the mold instead of hot air, for example by moving over a slide valve or an air-conducting flap, so that quick cooling of the fiber molding can take place. This allows short cycle times to be achieved, which increases the overall productivity of the installation. The mold may have separate, closable outflow openings for the cooling air, which are independent from the through-flow openings for the hot air, so that it is possible that cooling air can be blown into the mold both through the pressure-side through-flow openings and through the suction-side through-flow openings for the hot air. The outflow openings are then opened separately, so that the cooling air flows into the surroundings or is discharged, so that there is no circulation of the cooling air. Otherwise, the blower air may be circulated, in order to keep energy losses low and not to use air as a resource unnecessarily.

The mold is preferably formed such that it is divided along the feeding direction of the fibers. Specifically in the production of large, sheet-like parts, it is provided in the prior art that they are placed flat in molds, in order to heat them subsequently by a hot-air oven. In particular in the case of seat cushions or mattresses, it was not possible to achieve a good result here because the production times were too long and the fibers were not oriented in the correct direction. The hot air took the path of least resistance, so that the fibers were not evenly melted. As a result, thin locations of the shape were heated more quickly than the thicker locations of the fiber molding, which led to an uneven bonding of the fibers. If, however, the mold is longitudinally divided in the feeding direction of the fibers, it is possible to orient the fibers in an upright orientation of the finished fiber molding. An upright fiber can withstand compressive loading better than a horizontal fiber and behaves in a way similar to a brush, whereby improved elasticity and a certain memory effect are provided.

The outlet controller preferably has an adjustable flow-directing device, which is arranged between the mold and the closable outlet openings. The adjustable flow-directing device allows an alignment of the fibers within the mold to be achieved.

At least within the mold, as far as possible the fibers should not be transported or moved by means of compressed air, since the compressed air can cause undesired turbulence within the mold. By contrast, a suction or sucking-out flow can prevent turbulence. Therefore, at least within the mold, the fibers are preferably moved by means of the suction effect of an air stream. The direction and intensity of the through-flow in and outflow from the mold is of great significance for the position and alignment of the fibers. The reversal of the air flow or the transporting air within the mold may therefore be performed on the one hand by means of closure flaps, by means of which the air flow can be slowed down or completely interrupted in certain outflow regions of the mold and speeded up in other outflow regions, and on the other hand by means of the adjustable flow-directing device, which allows an air flow in one direction that is for example evenly distributed with respect to the linear extent of the mold. In this way, an even extraction of the air from the mold can take place through the through-flow holes, preferably not only in one specific region, for example in a lower region in which a closure flap is open, but over the entire region along the mold or that side of the mold in which the through-flow holes are arranged. The transporting air can thus flow or be extracted with the same intensity through all of the through-flow holes. The flow-directing device consequently allows the variability of the transporting air or the flows thereof into and out of the mold to be increased with respect to the speed and alignment. The flow-directing device allows a wide variety of air flows to be achieved in the mold for the alignment of the fibers.

It is provided according to the invention that the flow-directing device is formed over at least that region of the side of the mold in which the through-flow holes are arranged. This is preferably the longitudinal side of the mold. This makes it possible to produce an air flow that is aligned evenly over the entire outlet region of the mold side.

The flow-directing device may have perforated plates or slotted plates that can be displaced with respect to one another. In this case, the through-openings of the perforated or slotted plates arranged alongside one another are reduced or increased in size as the plates are displaced in relation to one another. The transporting air or the air flowing out from the mold can thereby be reduced or increased by means of the perforated or slotted plates. This allows the transporting air flowing out from the mold to be set according to requirements.

The flow-directing device may have slats, fins or blades arranged in the manner of a Venetian blind, which are mounted adjustably with respect to their inclination. The slats are respectively mounted preferably in a region of their front edge, so that a respective slat can be inclined or pivoted by means of turning the rear edge about the bearing point of the front edge. This allows a directed air flow to be achieved over a relatively great region of the mold.

It is provided according to the invention that the slats can be pivoted from a fully opened passing-through position, a neutral position, by respectively +/−90°. This allows a deflection of the air flow out of the mold from perpendicular to almost parallel to the feeding direction of the fibers. It also allows the outflow openings formed between the slats to be closed preferably completely by means of the slats when they are inclined to the maximum extent, so that no air from the mold can flow through the flow-directing device.

The slats can be activated individually and/or in groups. This makes it possible to produce discharge flows of different intensity and direction in different regions of the mold. Moreover, adapted inclining or pivoting of the slats of the flow-directing device in individual regions allows an interruption of the respective air stream to be achieved.

The slats and/or perforated plates of the flow-directing device may be coupled to a drive unit and are thereby preferably controllable in a motorized manner. According to the invention, the drive unit is suitable for activating the slats and/or perforated plates individually or in an interconnected manner and is preferably arranged laterally alongside the flow-directing device.

It is provided according to the invention that the slats of the flow-directing device are arranged one behind the other in the feeding direction of the fibers and, in a fully opened passing-through position, are respectively aligned in a plane perpendicular to the feeding direction of the fibers. This position of the slats is defined as the neutral position or 0° position.

The flow-directing device may have at least two units arranged alongside one another, by means of which individual slats and/or perforated plates or a group of slats and/or perforated plates can be respectively activated. In one embodiment of the invention, three units of the flow-directing device are arranged alongside one another, in order to be able to control three regions, with regard to the flow properties formed therein, by way of an outflow cross section. It is quite possible to arrange further units of the flow-directing device alongside one another, one above the other or else one behind the other. The flow-directing devices can be activated separately and/or in an interconnected manner, so that the air flows can be deflected or controlled in each individual region or in all of the regions together.

In one configuration of the invention, the outlet openings have closure devices for the outlet openings.

The closure devices are preferably adjustable individually and/or in groups in a motorized manner. The drive unit for controlling the slats and/or perforated plates is preferably also coupled to the closure devices for the outlet openings for opening or closing the outlet openings. The closure devices are in this case adjustable separately and/or in an interconnected manner with the slats and/or perforated plates of the flow-directing device.

The closure devices and/or slats are preferably made of wood. This avoids the possibility of the closure devices and/or slats becoming statically charged and fibers becoming attached to them, and as a result prevents for example complete closing or sealing off of an outlet opening.

It is provided that a seal is respectively formed between the outlet openings and the flow-directing device, so that overflowing of the air into a respectively neighboring channel or a neighboring outlet opening is prevented. As a result, a leakage of air through a passage or channel formed between two slats is prevented in particular.

It is provided according to the invention that in the mold there are regions with differently formed air flows and the speed of the air flow is designed to be greater in regions of small through-openings of the flow-directing device than in regions of large through-openings. The slats of the flow-directing device are adjustable in their inclination. The more the slats are inclined, the smaller the through-opening between the slats. With the same air mass or same mass flow through the through-openings, the speed of the flow is all the greater the smaller the through-opening between the slats. If the through-opening is completely closed, no air flow is formed. Consequently, not only the direction of flow but also the speed of flow of the transporting air into and out of the mold can be controlled by means of the degree of inclination of the slats.

The process according to the invention for producing a fiber molding from a thermally crosslinkable fiber material in which the fibers are transported into a mold by way of an air stream provides that the mold is of a divided form and is moved apart before the filling, the fiber material is compressed by closing the mold after the filling and the fiber material is subsequently heated by hot air until the fibers have bonded together, the fibers being oriented in the mold before compression perpendicularly to the feeding direction and in the direction of the air flowing out from the mold. The opening of the mold allows the filling volume to be increased significantly and mechanical compression caused by the closing of the mold allows a high degree of compression, which is significantly greater than that which can be achieved by a suction blower in an economically acceptable form.

The hot air is preferably passed through the mold and can be circulated along a route that passes through the blower, the heat exchanger and the mold.

It is also provided that the mold is assigned air-directing devices which are arranged one behind the other in the feeding direction of the fibers and have closure devices and, for filling the mold, the closure devices are opened starting with the one away from the feeding opening for the fibers and proceeding with opening them in the direction of the feeding opening. By opening the closure device that is furthest away from the feeding opening, the mold is filled slowly, without buildups or blockages occurring. The mold is advantageously arranged upright, so that the lowermost closure device is opened first, then the closure devices situated closer to the feeding opening are opened fully or partially, in order to fill the mold completely with the fiber material. The closure devices are advantageously opened one after the other, it also being possible for closure devices to be closed again after being opened during the filling operation, in order to be able to have control of the filling operation and influence over the orientation and the filling density. The controlled opening and controlled closing of the closure devices allows different density zones, and consequently different hardness zones, of the fiber molding to be realized.

After the bonding together of the fibers by supplying thermal energy, in particular hot air, the mold parts of the mold can be moved to the final size of the fiber molding and kept there for cooling. The moving of the mold parts to the final size is preferably performed in the heated state of the fibers, in which it is possible for the fibers still to undergo post-forming or deforming.

The fiber molding according to the invention of a thermally crosslinkable fiber material which has been crosslinked in a mold while thermal energy is supplied, the fiber molding having an upper side which is aligned perpendicularly to the main loading direction of the fiber molding, provides that the fiber molding is formed elastically in the direction of the main loading direction and has a main orientation of the fibers that is aligned in the direction of the main loading direction. This makes it possible to provide increased dimensional stability with at the same time elasticity for the fiber molding, so that it is particularly well suited in particular for uses in upholstered furniture and vehicle seats.

Preferably, at least 50% of the fibers are oriented longitudinally to the main loading direction, that is to say perpendicularly to the upper side of the surface of a sheet-like fiber molding.

An exemplary embodiment of the invention is explained in more detail below on the basis of the appended figures, in which:

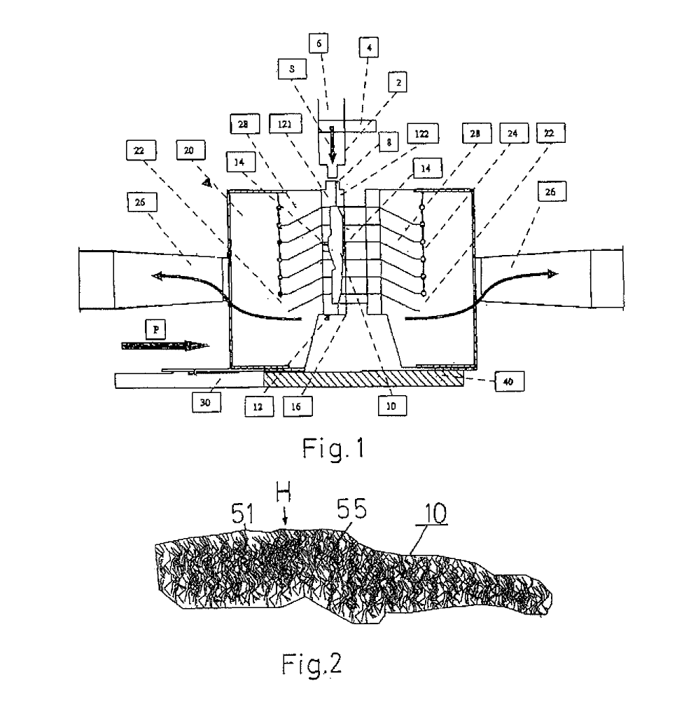

FIG. 1 shows a basic structure of the apparatus in a sectional representation;

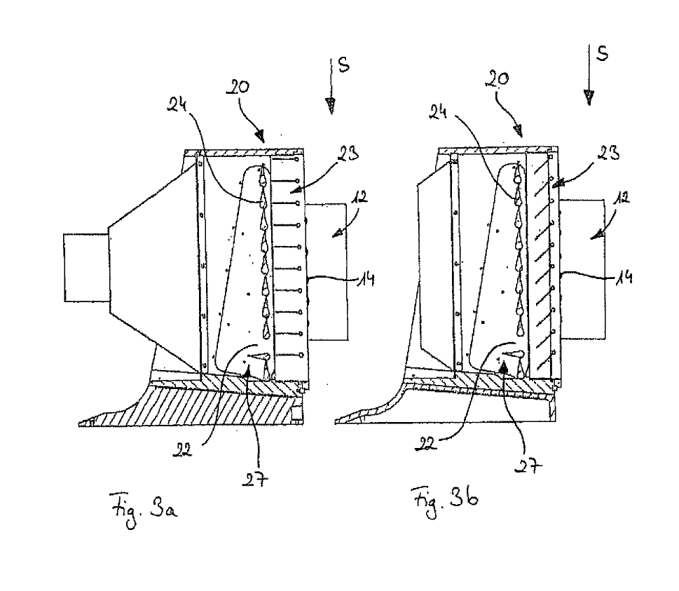

FIG. 2 shows a sectional representation of the molding; and

FIGS. 3a and 3b respectively show a sectional representation of the outlet controller.

In FIG. 1, an apparatus for producing a fiber molding is shown in a schematic sectional representation. The apparatus has a fiber-feeding device 2 in the form of a filling nozzle, to which a heating device and a heat exchanger 6 are assigned. In the filling nozzle of the fiber-feeding device 2, the fibers to be introduced into the mold 12 are provided and are introduced pneumatically into the mold 12 through the feed-in opening 8 schematically indicated in the region of the parting line of the mold 12. The mold 12 consists of two mold parts 121, 122, which are arranged on tool mounts. There may also be more than two mold parts. The left-hand mold part 121 and the associated tool mount are mounted on a carriage 30 so as to be displaceable on a frame 40. A compressive force P can be applied by way of the carriage 30, in order to displace the left-hand mold part 121 in the direction of the right-hand mold part 122. It is likewise possible to move the mold parts 121, 122 away from one another, in order to achieve an increase in the volume of the cavity within the mold 12, so that the fiber material can be introduced more easily. Subsequently, mechanical compression can be achieved by moving the carriage 30 in the direction of the fixed part of the mold 12.

Arranged within the mold 12 and the mold parts 121, 122 are through-flow holes 14, which are only schematically indicated. The through-flow holes 14 extend over the entire height of the mold 12 and allow the transporting air or the heating air to flow out laterally from the mold 12. Perforated plates 16, which prevent fiber material from being discharged from the mold 12, may be arranged in the mold 12 or on the mold 12.

FIG. 1 reveals that the longitudinal extent of the cavity of the mold 12 substantially follows the direction of gravitational force, that is to say that the mold 12 is aligned upright. Accordingly, the feeding direction S both of the fibers and of the transporting air is perpendicularly from above along the direction of gravitational force. Extending laterally from the mold parts 121, 122 are air-directing devices 28, which directly adjoin the mold 12. The air-directing devices 28 form shafts or channels, which are in flow connection with the through-openings 14. As can be seen from FIG. 1, the air-directing devices 28 take the form of plates or separating walls. The shafts or channels formed by the air-directing devices 28 are substantially separate from one another, so that no transporting air or heating air can flow out of through-openings 14 assigned to the respective channels through other channels. The channels open out into outlet openings 22, which can be closed by closure devices 24 in the form of flaps or slide valves. The outlet openings 22 open out into suction-air connections 26, which in the exemplary embodiment represented are arranged on both sides of the longitudinal extent of the mold 12 and both sides of the parting line. As a result, the transporting air stream that is initially oriented downwardly from above branches into two suction-air streams, which are discharged laterally and substantially at right angles to the feeding direction of the fibers, and consequently substantially horizontally.

The suction-air connections 26 may be arranged on a common blower, which may be coupled on the pressure side to the fiber-feeding device 2, so that a circulation of the working air is possible.

In the apparatus, an outlet controller 20 is provided for each side of the closure devices 24, so that the closure devices 24 lying opposite one another can be opened and closed individually.

In the exemplary embodiment represented, the lower closure devices are open, so that the regions that are isolated from the lower two air-directing devices 28 can be flowed through by the transporting air or the heating air. Fibers from the fiber bunker are then passed perpendicularly downward by way of the transporting air and pile up on top of one another, since the fibers are sucked in the downward direction. On account of the deflection of the flow by 90° in opposite directions, the fibers are directed with their longitudinal extent substantially parallel to the direction of flow, in order to offer as little air resistance as possible to the suction flow. This causes the airborne fibers to be piled and oriented in such a way that they are oriented perpendicularly to the parting plane of the two mold parts 121, 122. A large part of the fibers is therefore substantially perpendicular to the parting plane, and consequently substantially perpendicular to the large-area surfaces of the fiber molding 10.

For further charging, further closure devices 24 are opened one after the other, so that the closure devices are opened one after the other from the air-directing device 28 that is furthest away to the air-directing device 28 that is closest to the feed-in opening 8. There is also the possibility of closing individual closure devices 24 during the course of filling, in order to be able to realize different density profiles within the fiber molding.

After the filling of the mold 12, it is possible and envisaged also to direct hot air through the mold 12 through the feed-in opening 8. Alternatively, a suction-air connection 28 may be connected on the pressure side to a hot-air blower, so that a substantially horizontal hot air flow can be directed through the precompressed fiber molding, in order to activate the adhesive or bring about a frictionally engaging or materially bonding crosslinkage of the fibers. Conducting the air in such a way has the advantage that an even flow of hot air through the mold is realized, while at the same time an even bonding together of the fibers is ensured. The hot air flows through the mold 12 over a very short path, so that even heating of the fibers and of the fiber molding is achieved very quickly.

In FIG. 2, a schematic sectional view of a fiber molding 10 is shown in the form of seat upholstery. The fiber molding 10 is formed as a three-dimensional, flat component and has a surface 51, which is oriented substantially perpendicularly to the main loading direction H. On account of the fiber orientation aligned perpendicularly to the surface 51 and substantially parallel to the main loading direction H, the fiber molding 10 is elastic and additionally has a high recovery factor, so that great dimensional stability is ensured.

The fiber molding 10 consists substantially of a thermally crosslinkable fiber material 55, which has been introduced into a mold and oriented in such a way that the fiber material 55 is oriented substantially parallel to the main loading direction H, and consequently substantially perpendicularly to the upper side 51 of the fiber molding 10. Not all of the fibers of the fiber material 55 are in this case oriented parallel to one another, but rather there are in a fiber molding 10 that is produced by thermal crosslinking and is compressed in a mold while pressure and heat are supplied a wide variety of fiber orientations, which are also desired, since the overall stability, overall strength and dimensional stability of the fiber molding 10 are ensured by the different orientations. In order however to provide specific elasticities in the fiber molding 10, the elasticities being intended to act substantially in the main loading direction H, a large part of the fiber materials 55 is oriented in such a way that the longitudinal extent of the fibers is oriented substantially parallel to the main loading direction H. Different strengths can be achieved in individual regions of the fiber molding 10 by way of differences in density. It is also possible to achieve different strengths or elasticities by different orientations in individual regions of the fiber component 10.

The fiber moldings 10 may be used for example as upholstery materials, interior trim parts for motor vehicles, floor coverings, insulating materials or cushions for chairs or seats.

In FIGS. 3a and 3b, a basic structure of an outlet controller 20 is respectively shown in a schematic sectional representation. In this configuration of the invention, the outlet controller 20 has both closure devices 24 for the outlet openings 22 and an adjustable flow-directing device 23. The outlet controller 20 is arranged between the mold 12 and the suction-air connection 26, the adjustable flow-directing device 23 being arranged on a side of the outlet controller 20 that is facing the mold 12 and the closable outlet openings 22 being arranged on a side of the outlet controller 20 that is facing the suction-air closure 26.

Air-directing devices 28, as shown in FIG. 1, are not provided in this configuration of the invention. In this configuration, air-directing devices 28 may be arranged between the mold 12 and the adjustable flow-directing device 23 or between the adjustable flow-directing device 23 and the closable outlet openings 22. The air-directing devices 28 constitute rigid, non-adjustable baffles or channels and are preferably constructed in the form of a funnel, in order to bring about an adaptation of the suction-air connections 26 to the respective mold size. By contrast, the flow-directing device 23 has slats 25 and/or perforated plates that are movable or adjustable independently of one another, so that the air flow can be aligned or controlled individually.

The flow-directing device 23 is formed over at least that side region of the mold 12 in which the through-flow holes 14 are arranged. This makes it possible to deflect the transporting air or air flow within the mold 12 over this entire side region. The flow-directing device 23 directly adjoins the mold 12, preferably only one row of the through-flow holes 14 being arranged between two slats 25 of the flow-directing device 23. In this way, shafts or channels that are in flow connection with the through-flow holes 14 are formed between the slats 25.

The slats 25 of the flow-directing device 23 take the form of plates, separating walls or blades, so that the shafts or channels that are formed by means of the slats 25 are substantially separate from one another and the air flow cannot be influenced by a respectively neighboring channel. At least in a fully opened position of the slats 25, as shown in FIG. 3a, the channels open out directly in the region of the outlet openings 22, which can be closed by closure devices 24. In this position, the channels of the flow-directing device 23 are sealed off by means of seals between the outlet openings 22 and the slats 25 of the flow-directing device 23. The seals are respectively arranged either on the front edge of the outlet openings 22 or on the rear edge of the slats 25, so that an intermediate space respectively formed between the outlet opening 22 and the slats 25 is sealed off, at least in the neutral position of the slats 25 as represented in FIG. 3a.

In FIG. 3a, the flow-directing device 23 is shown in a position with a maximum through-opening. This position is referred to as the neutral position, the slats 25 being pivotable respectively by +/−90° about the neutral position. In the neutral position, the slats 25 of the flow-directing device 23 are respectively arranged in a plane perpendicular to the feeding direction S. As a result, the transporting air or heating air from a feeding direction S is deflected by 90°.

In the neutral position of the slats 5, as shown in FIG. 3a, the channels between the slats 25 and the slats 25 themselves preferably open out directly into the outlet openings 22. The outlet openings 22 can be closed by means of the closure devices 24, so that individual channels between the slats 25 can be closed by the closure devices 24 and, in the closed channels, the transporting air cannot be sucked in by the suction-air connection 26, or only partially. As shown in FIG. 3a, the air flow is consequently influenced only in the lower region, in which one of the closure devices 24 has been switched into a passing-through position and the outlet opening 22 in this region is open.

In this configuration of the invention, the slats 25 of the flow-directing device 23 are respectively pivotable on their front edges. The slats 25 can be switched individually and/or in groups. The distance between the slats 25 is made equal to or less than the distance between the front edge and the rear edge of a respective slat 25. This makes it possible that a slat 25 in a position +/−90° to the neutral position can close a respective outflow channel.

In FIG. 3b, the slats 25 of the flow-directing device 23 have been switched to an angle of approximately 45°, so that, when the transporting air is sucked in by the suction-air connection 26, the air flow in the mold 12 is deflected from the direction S over the entire region of the side of the mold 12 in which the through-flow holes 14 are arranged. As in FIG. 3a, in FIG. 3b it is also the case that only in a lower region of the mold 12 is the closure device 24 open, so that the air can only be sucked from this outlet opening 22. The slats 25 of the flow-directing device 23 switched to the 45° position have the effect that the transporting air is not only sucked from the mold 12 in a lower region but also from the regions above that in which through-flow holes 14 are formed on the mold 12. In this case, the greatest suction effect is in the lower region of the mold.

The position of the flow-directing device 23 that is represented in FIG. 3b is switched to when some fibers have already been aligned and collected on the bottom of the mold 12. The stronger suction effect in the lower region thus also acts through the already collected fibers. This makes it possible that the fibers fed in subsequently in the direction S are oriented or aligned in one direction in the upper region of the mold 12 by the evenly distributed, but less intensive air flow and then, in the lower region of the mold, after impinging on the already collected fibers within the mold 12, are sucked and held against the already collected fibers on account of the more intense suction effect in the lower region. This allows the fibers to be continuously aligned and piled on top of one another.

It is possible to arrange a number of flow-directing devices 23 alongside one another and activate them individually. For example, one flow-directing device 23 may be switched to the neutral position, as shown in FIG. 3a, and a flow-directing device 23 arranged alongside the first may be switched to the 45° position, as shown in FIG. 3b. This allows the air flow from the mold 12 to be controlled not only with respect to a direction parallel to the feeding direction S but also a direction perpendicular to the feeding direction S. Consequently, with a position of the flaps of the closure devices 24 represented in FIGS. 3a and 3b, it is possible to achieve an interruption of the air flow in one of the upper regions of the mold, at least in that region in which the flow-directing devices 23 have been switched to the neutral position, and to achieve an air flow distributed over the height of the mold in a neighboring region, in which the flow-directing devices 23 have been switched to the 45° position.

1. An apparatus for producing a fiber molding (10) comprising a pneumatic fiber-feeding device (2) with an assigned heating device (4) having at least one heat exchanger (6) for heating heating air and a mold (12) which has on at least one side through-flow holes (14) for the transporting air, characterized in that the mold (12) has an outlet controller (20) which is arranged on the side of the through-flow holes (14) and has a number of closable outlet openings (22) arranged one behind the other in the feeding direction of the fibers.

2. The apparatus as claimed in claim 1, characterized in that a suction-air connection (26) is arranged behind the outlet controller (20) in the direction of flow of the transporting air.

3. The apparatus as claimed in claim 1, characterized in that the outlet controller (20) has flaps or slide valves as closure devices (24) for the outlet openings (22).

4. The apparatus as claimed in claim 1, characterized in that in the mold (12) there are regions for different fiber densities or fiber thicknesses and the free flow cross section of the through-flow holes (14) is greater in regions of great fiber density or fiber thickness than in regions of low fiber density or fiber thickness.

5. The apparatus as claimed in claim 1, characterized in that the mold (12) is divided and the mold parts (121, 122) are mounted displaceably in relation to one another.

6. The apparatus as claimed in claim 1, characterized in that the mold (12) is arranged in such a way that the feeding direction (S) of the fibers corresponds substantially to the direction of gravitational force.

7. The apparatus as claimed in claim 1, characterized in that air-directing devices (28), which separate the outlet openings (22) from one another, are arranged between the mold (12) and the outlet controller (20).

8. The apparatus as claimed in claim 1, characterized in that the mold (12) is formed such that it is divided along the feeding direction (S) of the fibers

9. The apparatus as claimed in claim 1, characterized in that the outlet controller (20) has an adjustable flow-directing device (23), which is arranged between the mold (12) and the closable outlet openings (22).

10. The apparatus as claimed in claim 9, characterized in that the flow-directing device (23) extends over at least that side region of the mold (12) in which the through-flow holes (14) are arranged.

11. The apparatus as claimed in claim 9, characterized in that the flow-directing device (23) has perforated plates or slotted plates that can be displaced with respect to one another.

12. The apparatus as claimed in claim 9, characterized in that the flow-directing device (23) has slats, fins or blades (25) arranged in the manner of a Venetian blind.

13. The apparatus as claimed in claim 12, characterized in that the slats (25) are mounted adjustably in their inclination between 0° and 90°.

14. The apparatus as claimed in claim 12, characterized in that the slats (25) can be activated individually and/or in groups.

15. The apparatus as claimed in claim 11, characterized in that the slats (25) and/or perforated plates are adjustable in a motorized manner.

16. The apparatus as claimed in claim 12, characterized in that, in a fully opened passing-through position, the slats (25) are respectively arranged in a plane perpendicular to the feeding direction (S) of the fibers.

17. The apparatus as claimed in claim 9, characterized in that at least two flow-directing devices (23), each with a group of slats (25) and/or perforated plates, are arranged alongside one another, one above the other or else one behind the other between the mold (12) and the closable outlet openings (22), and the flow-directing devices (23) can be activated separately and/or in an interconnected manner.

18. The apparatus as claimed in claim 9, characterized in that the outlet controller (20) has closure devices (24) for the outlet openings (22) and the closure devices (24) are adjustable individually and/or in groups in a motorized manner.

19. The apparatus as claimed in claim 18, characterized in that the closure devices (24) are adjustable separately and/or in an interconnection with the flow-directing device (23).

20. The apparatus as claimed in claim 12, characterized in that the closure devices (24) and/or slats (25) are made of wood.

21. The apparatus as claimed in claim 9, characterized in that a seal is formed between the outlet openings (22) and the flow-directing device (23).

22. A process for producing a fiber molding from a thermally crosslinkable fiber material in which the fibers are transported into a mold {12), provided with through-flow openings (14), by way of an air stream, the mold (12) being of a divided form and moved apart before the filling, the fiber material being compressed by closing the mold (12) after the filling and the fiber material subsequently being heated by hot air until the fibers have bonded together, the fibers being oriented in the mold (12) before compression perpendicularly to the feeding direction (S) and in the direction of the air flowing out from the mold (12).

23. The process as claimed in claim 22, characterized in that the mold (12) is assigned air-directing devices (28) which are arranged one behind the other in the feeding direction (S) of the fibers and have closure devices (24) and, for filling the mold {12), the closure devices {24) are opened starting with the one away from the feeding opening {8) for the fibers and proceeding with opening them in the direction of the feeding opening (8).

24. The process as claimed in claim 23, characterized in that the closure devices (24) are opened one after the other.

25. The process as claimed in claim 23, characterized in that closure devices (24) are closed again after being opened during the filling operation.

26. The process as claimed in claim 22, characterized in that, after the bonding together of the fibers, the mold parts (121, 122) are moved to the final size of the fiber molding (10) and kept there for cooling.

27. A fiber molding of a thermally crosslinkable fiber material (55) which has been crosslinked in a mold while thermal energy is supplied, the fiber molding (10) having an upper side (51) which is aligned substantially perpendicularly to the main loading direction (H) of the fiber molding (10), the fiber molding (10) being formed elastically in the direction of the main loading direction (H) and having a main orientation of the fibers that is aligned in the direction of the main loading direction (H).

28. The fiber molding as claimed in claim 27, characterized in that at least 50% of the fibers are oriented longitudinally to the main loading direction (H).
